(19) United States
(12) Patent Application Publication
(10) Pub. No.: US 2010/0258356 A1
(43) Pub. Date: Oct. 14, 2010

(54) Refrigerator for obese persons

(76) Inventors: Aparna Thirumalai Anandampillai, Chennai-88 (IN); Vijayan Thirumalai Anadampillai, Chennai-88 (IN); Anandvishnu Thirumalai Anadampllai, Chennai-88 (IN)

Correspondence Address: T.A. APARNA, 19, 1 STREET, PARTHASARATHY NAGAR,, ADAMBAKKAM,CHENNAI-88, CHENNNAI-88, TN, 600088, IN

(21) Appl. No.: 12/799,645

(22) Filed: Apr. 29, 2010

(30) Foreign Application Priority Data
Nov. 27, 2008 (IN) PCT/IN2008/000078

(51) Int. Cl. G01G 19/40

(52) U.S. Cl. 177/25.16

(57) ABSTRACT

This is a modified fridge (1) with a food weighing balance (5), a visual display (2) with in built electronic control, input keys (3) and speaker (4). Pre-weighed food containers (6) are kept in a clean washable clean rack (7) fitted to sides or top. The electronic control with appropriate processor input and output devices, circuits and software integrates the fridge with food balance and visual display and speaker. User enters his code, opens fridge and loads in pre-weighed food container (6) his food and weighs it. The food type and container code are entered by input keys (3). The food balance calculates the food weight alone and sends to electronic control which calculates the calorie. Additional food of that meal is also weighed. The control calculates that meal, daily, weekly or monthly calorie chart and displays it. Similar charts for water, and other nutrients can be displayed Reflective mirror film (8) motivates for good control of eating.

### TECHNICAL FIELD

This invention in general relates to refrigerators with weight reducing, diet monitoring and diet advising added functions.

### STATE OF ART

Existing refrigerators (fridges) store and preserve food. There are no diet advising, weight monitoring fridges as of now. Fridges may have music, TV, internet but none for weight control. Fridges are the main source and cause of over eating. Ideal weight control fridges should be: 1. Monitor what we eat. 2. Should advice, tabulate daily, weekly, monthly caloric balance. 3. Advise users and doctors. 4. Easy to use, safe and reliable. There are no weight reducing fridges as of now!

The following description gives critical examination of the refrigerators known till date. It also discusses the shortcomings of the conventional fridges. Further in order to overcome the problem associated with weight control, the invention offers the solution to overcome the impediments in the construction and the process of using the same.

Constraints in all refrigerators are as follows:
1. There is only just food storing, making more eating.
2. They are not useful for weight control, advice and monitoring.
3. There is no useful nutrition from the fridges but only overeating and obesity.
4. Does not display body size to decrease appetite and motivate to eat correctly.
   Accordingly the object of the invention is to identify the solutions for problem associated with the conventional refrigerators in the fight against obesity. An extensive search has been carried out using the Internet and related patent specifications were studied for refrigerators that can control weight and allow good correct nutrition. Since the present invention is radically different, in using the same refrigerator for weight control and correct nutrition, the inventor is unable to site any patent specification out of the available databases. Only separate refrigerators and weight reducing gadgets are seen globally. The invention is directed to a novel type of easy diet control and good nutrition advising refrigerators even for kids and women to use to avoid childhood, adolescent and adult obesity complications.

Accordingly it is the primary object of the invention to invent a novel weight reducing refrigerators, which is unique in design and construction, working and use. Further objects of the invention will be clear from the ensuing description.

### SUMMARY OF THE INVENTION

The device comprises of a refrigerator with a food weighing balance, an electronic display, an audio speaker and an electronic control that records the food and liquid eaten, convert that into caloric data, add up daily, weekly, monthly totals. The control is connected to the food weighing balance and the refrigerator. Special pre-weighed containers filled and placed on weighing balance identify the food weight and its calories. The calories are added and matched with needed daily calories. Excess food calories sets alarms and alternate diet type and quantity are also suggested. The fridge door has a mirror film pasted to tell us our size before eating.

### STATEMENT OF DRAWINGS

These and other objects and features of the invention will become more apparent upon perusal of following description taken in conjunction with accompanying drawings wherein:

FIG. 1 shows in elevation the details of fridge

FIG. 2 shows the various components of the new fridge

### DESCRIPTION OF PREFERRED EMBODIMENTS

The following specification describes salient features of invention, the method of construction, the method of use and the advantages of the novel invention.

Fridges till date have no integrated food balance or calorie counter. Some fridges have TV or LCD with internet but none as weight and food monitor. Ordinary fridge is not illustrated nor detailed of its parts as it is well known.

The novel fridge has the normal fridge with a top food weighing electronic balance, a small visual display with audio speaker and an electronic control. The weighing balance is electronic type to weigh say up to 5 Kgs. An LCD display with input keys displays caloric data or can input the control. Pre-weighed marked containers load the food for easy input. The control calculates all inputs to create a calorie data of all home inmates for effective weight control. A reflecting mirror film on the door makes the person to control overeating as soon as he stands before the fridge.

The novel fridge according to invention is better because the all eating and drinking is inputted at home. Special feature of the invention is that it is easy to set up, run, and use even by kids too.

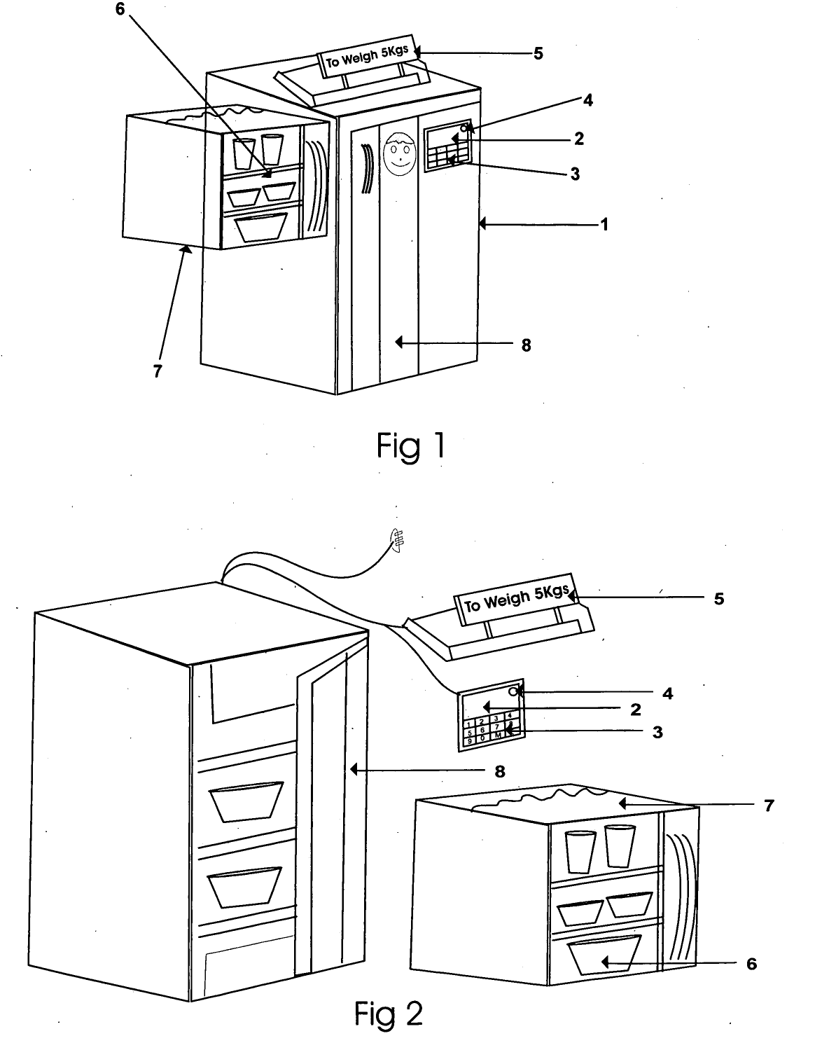

The device comprises of an appropriate sized refrigerator 1. It has an electronic control with a LCD display 2 with input keys 3 and a speaker 4 and is fixed on the fridge door or sides. An electronic weighing balance 5 for 5 Kg weighing is placed on top of fridge. An electronic circuit in the display using processors and flash memory or mini hard disk integrates the fridge, display and the weighing balance and forms the electronic control. It also has an Infrared, pin jack, USB port, WIFI or blue tooth for transfer to a cell phone or pen drive to show to health expert. A food container rack 7 with all pre-weighed containers 6 as cups, plates, tumblers, glasses etc is fitted to a side of fridge. This rack may be open or closed with a door. Needed shelves for plates, cups, tumblers for a family for 2 for more meals may be assembled in the rack. In the simplest form shown in FIG. 1 it is a rack formed of stainless steel stiff welded rods with a cleanable transparent plastic cover with a front flap (shown folded up) for use of the needed food container. A reflecting mirror film 8 is pasted on front door and helps us to eat less. This gives a life size image of the user (not a small LCD display) and motivates for good, correct eating. By looking in the mirror we know our full size.

As the fridge is opened the display asks for user name input. This is entered in input key 3. The fridge opens and food is taken in pre -weighed container 6 and placed on the food balance. The display asks type of food and container code entered by input key 3. The control calculates the weight and calories and displays. Each serving is inputted and calorie charted for that meal, then daily, weekly or monthly. If the daily eating is more than planned, the control gives a display and or audio warning. The weekly/monthly caloric data is tabulated and can be transferred to mobile phone, USB pen device or IR/blue tooth devices. The fridge can be modified. The food caloric values may be printed inside the fridge. So people know all caloric value of foods. The weighing balance may be on one side and food container rack on top. Food container rack and food balance may be on top of fridge. The food container rack may be of closed type with a door and made of metal or plastics. The electronic control is made as a LCD display with input keys, with main processor chip, input output circuits, an upgradable memory with all food caloric values and output devices as blue tooth/Infra Red, USB socket, etc. The LCD display can back up as radio, TV or display messages while eating with needed added circuit. The soft wares may be of any form or language (C+, java, dot net, etc). Any food eaten outside home can be inputted by keys 3 to complete day's calorie count. Calories burnt from pedometers may be fed to the control for a daily calorie tabulation of excess or deficit. Like calories, water content and other nutrients can be calculated and displayed using weight and water or nutrient data of foods. A silver coated reflective plastic film forms a simple low cost low weight (no stress on door hinges) mirror that can be pasted on the door for a visual help in sizing our body size that motivates for lower correct eating. Touch screen display may be used.

It will be apparent to those skilled in the art that modifications to the invention described herein can readily be made without departing from the spirit of the invention. Protection is sought for all the subject matter described herein including any such modifications.

### Advantages of the New Invention

1. Easy food weighing and calories counting before eating.
2. Daily, weekly and monthly caloric charts of food taken.
3. Warning of over eating before eating.
4. Alternate lower caloric food type and weight suggestion.
5. Audible and visual alarms of over eating or cheating
6. Easy chart output data transfer for doctor review.
7. Multiple users can count calories.
8. Easy updating of software
9. Reflecting Mirror on door is a big visual motivation before eating.
10. It economises food costs and saves money and health

We claim:

1. A weight controlling fridge comprising a fridge (1) wherein the improvement comprises of additional integrated food weighing electronic balance (5), an electronic control with an electronic display (2) with input keys (3) and a pre-weighed food containers (6) in a rack (7), the said fridge having the said appropriate food weighing balance on top, the said electronic display (2) also having an audible warning audio speaker (4), the said fridge with weighing balance and display having relevant electrical connections, the said display having the needed software for diet calorie calculation and display, the said fridge having printed calories on its inside.

2. A weight controlling fridge as claimed in claim 1 wherein, the said electronic control with a visual display (2) and audible speaker (4) is fixed in the door or side of the fridge, the said control having the electrical power supply from the fridge main circuit, the said control has an appropriate computing chip with inputs from the weighing balance and the display keys, the said electronic control integrating the food type and weight with relevant caloric values, then sorting this as a meal chart, daily, weekly, monthly charts, displaying the eaten food value and the balance for that meal and alternative food types and weight, if excess shows an alarm.

3. A weight controlling fridge as claimed in claim 1 wherein the said electronic food balance (5) to weigh the food is connected to fridge mains electrical power, has the input of the food container and food code, an output of the food weight sent to the said control, the food balance forming another input for the said electronic control, the food balance having a power cutting off circuit soon after weighing.

4. A weight controlling fridge as claimed in claim 1 wherein the said food rack (7) is assembled on the sides or top of the fridge, the rack having a dust proof clean protected washable clean surface to store the pre-weighed containers (6) as plates, cups, tumblers etc, the said fridge having printed calories on its inside

5. A weight controlling fridge as claimed above wherein the door has a reflective mirror film (8) to show us our body size and motivate for the eating control.

6. A weight controlling fridge as claimed above wherein the software integrates, the fridge, food balance, food container and food values, the software in any software form or language asks for the user identity, his calorie plan for day, week or month, weighs each food intake, calculates its weight excluding the container multiplies its caloric/water/nutrient value, tabulates meal total against planned meal, advises the balance calories for the day and displays the alternate menu and weight, creates daily weekly and monthly chart, transfers a read out for transfer to a display or mobile phone or email.

7. A weight controlling fridge as claimed in claim 1 wherein the electronic control has added input and output devices as IR, WIFI, blue tooth or USB for data transfer.
